(19) United States
(12) Patent Application Publication
(10) Pub. No.: US 2004/0038678 A1
(43) Pub. Date: Feb. 26, 2004

(54) Cellular radiocommunication system with means for locating faulty terminals

(76) Inventors: Pierre Lescuyer, Montigny-le Bretonneux (AR); Thierry Lucidarme, Mogtigny-le Bretonneux (AR)

Correspondence Address: PIPER RUDNICK, P. O. BOX 64807, CHICAGO, IL, 60664-0807, US

(21) Appl. No.: 10/312,933

(22) PCT Filed: Jun. 27, 2001
(86) PCT No.: PCT/FR01/02036

(30) Foreign Application Priority Data
Jun. 30, 2000 (FR) 0008486

(51) Int. Cl. H04M 3/42

(52) U.S. Cl. 455/424; 455/415; 455/558; 455/433

(57) ABSTRACT

The invention concerns a cellular system comprising a network core (10) including switches (11-13) and subscriber management means (14) and a radio access network (20) connected to the network core and including base stations (21) capable of radio communication with mobile stations (30) comprising each a terminal (31) associated with a subscriber identification module, for sending to the network core a warning message identifying a mobile station for which a dysfunction has been detected. When such an warning message identifying a mobile station is received, the network core queries the mobile station, so as to find out the identity of its terminal which is then recorded in a database of the network.

The present invention relates to cellular radiocommunication networks.

Current cellular networks make a distinction between the subscribers and the terminals which they use.

A mobile station communicating with the network is the association of a non-specific terminal of the subscriber and of a subscriber identification module (SIM) inserted into the terminal.

This SIM module contains data which, together with the corresponding data stored in a database of the network, called the HLR (“Home Location Register”), make it possible to identify the subscriber and to supply him with the services to which he has subscribed. These data comprise in particular a subscriber number called the international mobile subscriber identity (IMSI).

The terminal also has an equipment number called the international mobile equipment identity (IMEI). The structure of the IMEIs is described in the 3G TS 22.016 technical specification, version 3.1.0 published in December 1999 by the 3GPP (3rd Generation Partnership Project). Independently of the subscriber associated with it, the terminal stores its IMEI and communicates it to the network on request. To establish a communication, the option of designating the mobile station by the IMEI of its terminal may be provided. However, in general, it is the identity of the subscriber (IMSI) which is used by the network to address itself to a mobile station, thereby making it possible to provide the services of the network to the subscribers independently of the equipment which they use. Cellular networks of GPRS (“General Packet Radio Service”) and UMTS (“Universal Mobile Telecommunications System”) types can comprise an optional database called the EIR (“Equipment Identity Register”), in which IMEIs are stored. The EIR, consultable by the switches of the network, contains a “white list” of IMEIs for which use is allowed, a “black list” of prohibited IMEIs (for example, stolen terminals) and possibly a “gray list” of IMEIs which the operator can track in the network.

An aim of the present invention is to allow the operators of cellular networks to detect and deal with operating problems possibly affecting the terminals, while the mobile stations are identified on the basis of the subscriber identities rather than on the basis of the terminals.

The invention thus proposes a cellular radiocommunication system comprising on the one hand a network core comprising switches and subscriber management means and on the other hand at least one radio access network connected to at least one switch of the network core and comprising base stations capable of communicating by radio with mobile stations, each mobile station comprising a terminal associated with a subscriber identification module. The network core comprises means of interrogation of a mobile station through the access network so as to obtain an identity of the terminal of the interrogated mobile station. According to the invention, the access network comprises means for detecting defects of the mobile stations, so as to address to the network core a warning message identifying a mobile station for which a defect has been detected. The means of interrogation are controlled to interrogate a mobile station in order to obtain the identity of its terminal in response to the receipt of a warning message identifying said mobile station.

The defects are detected in the access network which is not necessarily provided with means making it possible to obtain the identities of the terminals in question. With the proposed system, the network core recovers the information making it possible to identify the faulty terminals, and can perform all kinds of actions in consequence: notify the holders of faulty terminals, prevent them from using these terminals should there be a problem which might greatly disturb the communications of other subscribers, alert the manufacturers should problems be picked up on a series of terminals, etc.

In a preferred embodiment, the network core comprises at least one database of faulty terminals containing records relating to terminals whose identity has been obtained by the means of interrogation in response to the receipt of a warning message. These records may comprise other elements contained in the warning message, such as a subscriber identity serving to identify the mobile station, an indication of type or of level of severity of the defect detected, etc.

The defects detected pertain in particular to the power transmitted by the mobile stations. They may also relate to other aspects such as errors of implementation of the communication protocols used between the radio access network and the mobile stations or excessive use, by a mobile station, of radio resources shared with other mobile stations.

Another aspect of the invention pertains to a network core for a cellular radiocommunication system, comprising switches and subscriber management means, the switches being connected to at least one radio access network comprising base stations capable of communicating by radio with mobile stations, each mobile station comprising a terminal associated with a subscriber identification module. The network core comprises means of interrogation of a mobile station through the access network so as to obtain an identity of the terminal of the interrogated mobile station. These means of interrogation are controlled to interrogate a mobile station in order to obtain the identity of its terminal in response to the receipt of a warning message identifying said mobile station.

A third aspect of the invention pertains to a radio access network for a cellular radiocommunication system, comprising base stations capable of communicating by radio with mobile stations and radio network controllers connected to switches of a network core, which supervise the base stations and ensure control of the radio resources in the access network. This access network according to the invention comprises means for detecting defects of the mobile stations, so as to address to the network core a warning message identifying a mobile station for which a defect has been detected.

Other features and advantages of the present invention will become apparent in the description below of nonlimiting exemplary embodiments, with reference to the appended drawings, in which:

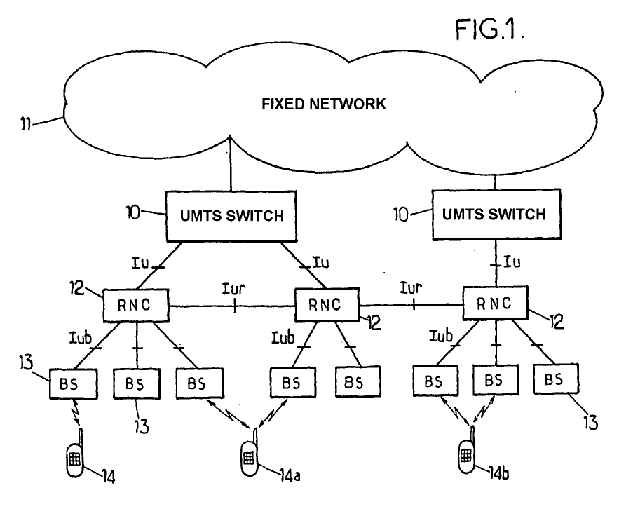

FIG. 1 is a general diagram of a cellular radiocommunication system architecture according to the invention;

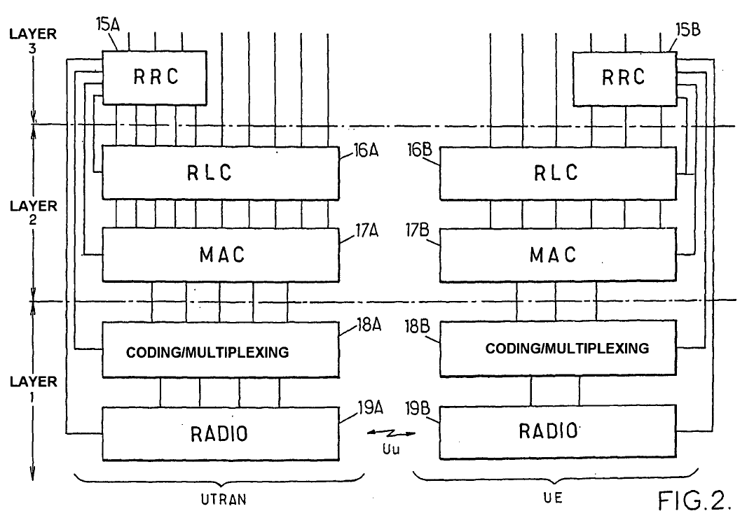

FIG. 2 is a chart illustrating messages exchanged in a system according to the invention;

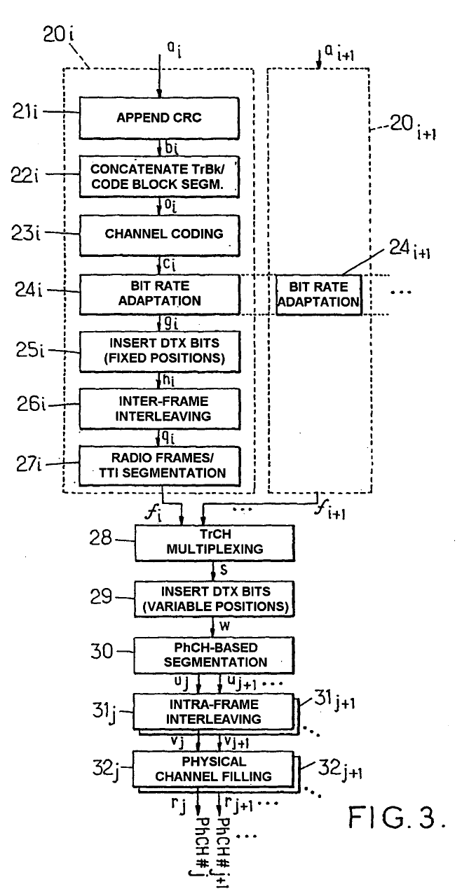

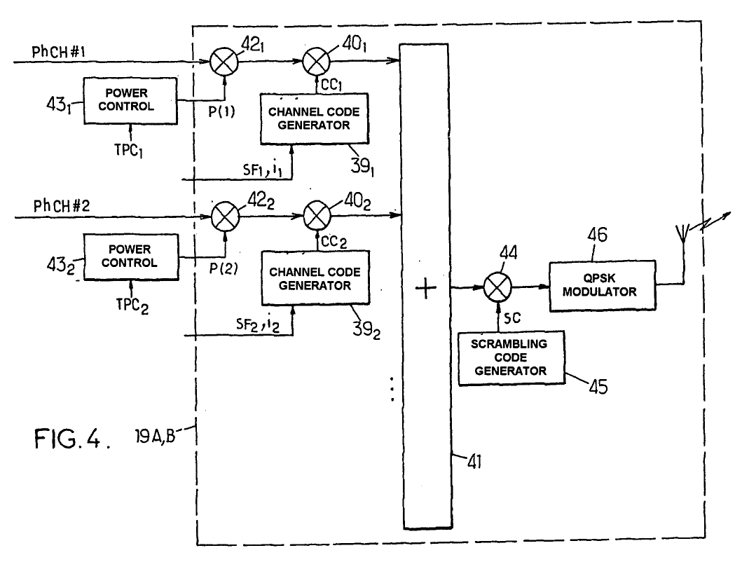

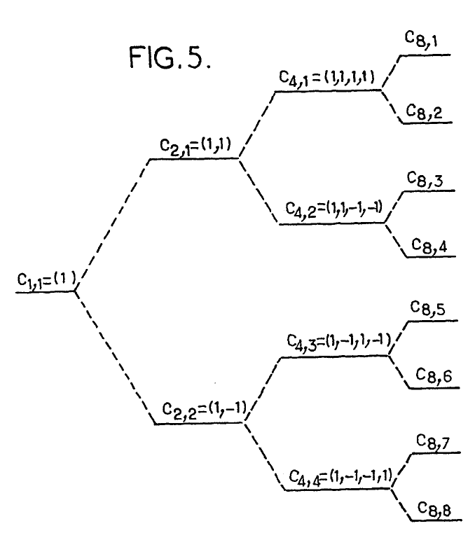

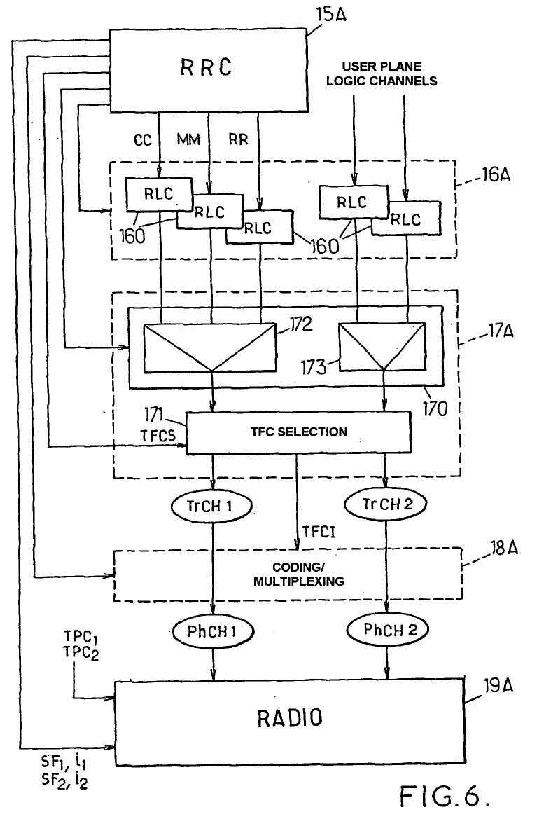

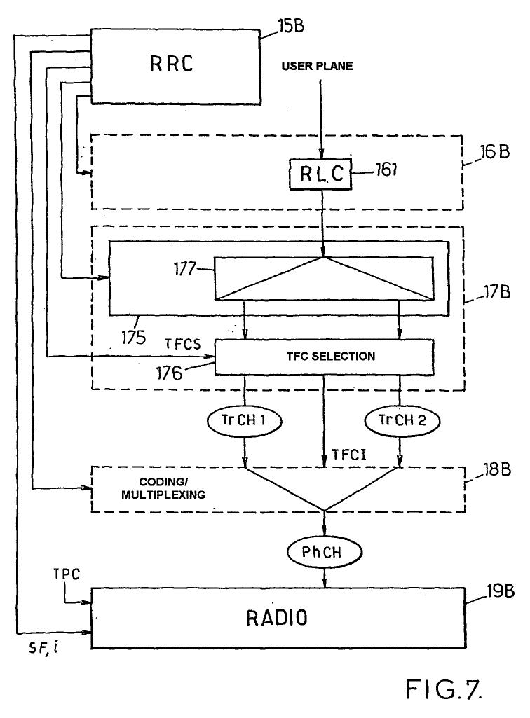

FIG. 3 is a chart showing communication protocols used in various parts of the system.

The cellular radiocommunication system represented in FIG. 1 comprises a cellular network with extended coverage of UMTS type. This cellular network, or PLMN (“Public Land Mobile Network”), is conventionally divided into a network core 10, comprising interconnected switches, and one or more access networks 20 providing the radio links with the mobile stations 30 called the UE (“User Equipment”).

Each UE 30 is composed of a terminal equipment 31 associated with a subscriber identification module (SIM) 32. The SIM 32 comprises a processor and a memory in which are recorded data relating to the subscriber, in particular his IMSI identity. Each terminal 31 also has an international mobile equipment identity (IMEI).

The access network 20, called the RAN (“Radio Access Network”), comprises units called “node B” 21 distributed over the area of coverage of the network and each comprising one or more base stations for communicating by radio (Uu interface) with the mobile stations 30. Subsequently, in the present description, a base station will be equated with its “node B” 21. Radio network controllers (RNC) 22 connected to the network core 10 supervise the base stations 21 through interfaces called Iub. Certain RNCs 22 are connected together through interfaces called Iur.

The access network considered here is of the UTRAN type (“UMTS Terrestrial RAN”) standardized by the 3GPP. It will be noted that the invention described is also applicable to other types of access networks, in particular to BRANs (“Broadband RANs”).

The network core 10 is connected to fixed networks comprising a public switched telephone network (PSTN) 8 and one or more packet transmission networks using respective protocols such as X.25 or IP (“Internet Protocol”). In the example illustrated by the drawings, there is a packet transmission network 9 constituted by the internet network.

The network core 10 comprises mobile service switching centers 11 (MSC, “Mobile Switching Center”) associated with visitor location registers (VLR). These MSCs 11 ensure the circuit switching for the circuit mode data transfer or telephony communications. Certain MSCs serve as gateway with the fixed networks, in particular with the switched network 8. Each RNC 22 is connected to one or more MSCs 11 by an Iu interface.

For the packet mode, the switches of the network core 10 are called GSNs (“GPRS Support Nodes”) and they communicate with one another through an interface called Gn.

The packet switches 12 connected to the RNCs 22 of the access network 20 by an Iu interface are called SGSNs (“Serving GSNs”). Some of them can communicate with MSCs via a Gs interface so as to coordinate the mobility between the circuit mode and the packet mode.

Other packet switches 13 of the network core 10, which are called GGSNs (“Gateway GSNs”), serve as gateway with the packet networks, in particular with the Internet network 9. These gateways 13 are connected to the SGSNs 12 so as to allow the UEs 30 to access the Internet.

The MSCs 11 and the SGSNs 12 incorporate call control units for exchanging information with the UEs 30 through the RAN 20, in particular within the framework of the setup and end of session procedures. The switch has in particular the possibility of interrogating the UE so that the latter returns its IMEI to it.

The network core 10 comprises a home location register 14 (HLR) communicating with the MSC/VLR, SGSN and GGSN through standardized interfaces called D, Gc and Gr respectively. The HLR is a database situated at one or more places, containing all the data specific to the subscribers of the PLMN, in particular their subscription and mobility parameters and their contexts, so as to allow the processing of all the service requests relating to these subscribers.

The network core 10 furthermore comprises a register of faulty terminals 15 which is a database wherein are recorded the IMEIs of terminals 31 for which the access network 20 has noted defects. This register 15 is here called the CMC (“Crazy Mobile Center”). When the network core 20 comprises an EIR, the CMC and the EIR can be situated in different items of equipment of the network or in the same item of equipment. In the latter case, the two databases will generally be held separately. It would always be conceivable for the functionality of the CMC to proceed by enhancement of the database of the EIR and of the corresponding protocols. The CMC 15 can also be situated in the same item of equipment of the network as the HLR 14.

The process for creating a record in the CMC 15 is illustrated by FIG. 2, the system entities brought into play by this process being shown in FIG. 3, in the form of logic modules applying the relevant protocols.

It is assumed that the UE 30 and a switch of the network core 10 (MSC 11 for the circuit mode or SGSN 12 for the packet mode) have, in a conventional manner, exchanged session setup signaling in the course of a call control procedure, this signaling allowing the switch to associate the IMSI of the UE with the open session.

When the RAN 20 detects a defect of the UE 30 in the course of the session, it advises the switch thereof in a STATUS_REPORT message having fields containing:

the IMSI of the subscriber, which is known to the RNC 22;

an indication “CAUSE” of the type of defect detected;

an indication “NSV” of the level of severity of the defect detected.

This STATUS_REPORT message can be integrated into the application protocol of the radio access network (RANAP, “Radio Access Network Application Part”), defined on the Iu interface (FIG. 3). This RANAP protocol is described in the 3G TS 25.413 technical specification, version 3.1.0. published in December 1999 by the 3GPP.

On receipt of this STATUS_REPORT message, the switch 11 or 12 interrogates the UE (IDENTIFICATION_REQUEST message) to request its IMEI, which is returned by the UE in the IDENTIFICATION_RESPONSE response message. These IDENTIFICATION_REQUEST and IDENTIFICATION RESPONSE messages belong to the mobility management protocols (MM, “Mobility Management” for the circuit mode and GMM, “GPRS MM” for the packet mode), and are relayed in a transparent manner by the RAN 20 as shown by FIG. 3.

The switch 11 or 12 then addresses an update command to the database 15 (UPDATE message), by providing the IMEI and the IMSI of the mobile station 30, as well as the CAUSE and NSV indications. The UPDATE message is acknowledged and a record is created in the database 15 with the data IMEI, IMSI, CAUSE and NSV.

This UPDATE message can be integrated into the mobility application protocol (MAP, “Mobile Application Part”) described in the 3G TS 29.002 technical specification, version 3.4.0. published in April 1999 by the 3GPP. If the CMC coincides with an EIR, the interface F′ between the MSC and the CMC can consist of the standardized interface F between the MSC and the EIR, and the interface Gf′ between the SGSN and the CMC can consist of the standardized interface Gf between the SGSN and the EIR. Otherwise, these interfaces F′ and Gf′ can be embodied in a similar manner to the standardized interfaces F and Gf.

The management of the database of the CMC 15 by the operator of the cellular network can comprise one or more of the following actions:

1/ Sending a message to the holder of a faulty terminal so as to signal the problem to him and/or invite him to change his terminal. This may be performed in particular by means of a short message server 16 (SMS: “Short Message Service”) present in the network core 10. If this is not done upon receipt of the warning message, the IMSI is recovered from the database 15 and before sending the alert message, the switch interrogates the UE again to check whether there is still the same IMEI/IMSI association. Failing this, the alert message is not sent.

2/ Preventing the UE whose terminal forms the subject of a record in the database 15 from communicating by way of the RAN 20. This can be done by ending the session in progress with the UE. The switch can furthermore bring about the recording of the IMEI of the faulty terminal in the HLR 14, in conjunction with the IMSI appearing in the database 15. In this case, when a network service is requested for the subscriber in question, the MSC or SGSN interrogates the UE to obtain its IMEI and determine whether the subscriber is still using his faulty terminal identified in the HLR. If so, the service can be refused.

3/ Signaling to the manufacturers batches of faulty terminals, located in accordance with the IMEIs appearing in the CMC 15.

These actions can be selected or modulated as a function of the parameters CAUSE and/or NSV which are to be found in the records, or else as a function of the number of records of which a given IMEI has formed the subject in the CMC 15.

According to a variant embodiment in which there is not necessarily any register of faulty terminals, the receipt of the ID_RESPONSE message by the switch triggers the recording in the HLR of the IMEI of the faulty terminal in conjunction with the associated IMSI.

Next, in the processing of a registration request (IMSI_ATTACH) received through the radio access network 20 from a UE 30 identified by this IMSI, the HLR will request the switch 11 or 12 to interrogate this UE so as to obtain its IMEI. The IMEI thus recovered is compared with that stored in the HLR, and should they match, one of the actions 1/ and 2/ hereinabove may be accomplished, namely alert the subscriber that he is using a terminal whose network has detected defects or reject the registration request so as to prevent the UE from communicating by way of the RAN 20.

A defect of the mobile terminals which exhibits particular importance for cellular operators is that of excessive transmission power. This problem may in fact greatly disturb communications involving other subscribers. The UMTS standards provide for regulation of the transmission power of terminals, but a faulty terminal might not follow this regulation.

Such a defect is detectable in the access network 20 on the basis of the power control loops.

This power control is supervised by the module of the RNC 22 which is responsible for the radio resources control protocol (RRC, “Radio Resource Control”). The latter defines a target signal-to-interferers ratio (SIR_{target}), which it communicates to node B 21 serving the UE 30. Node B evaluates whether the signal-to-interferers ratio (SIR), measured by the channel equalizer in the physical layer (PHY) is greater or less than the target SIR_{target}, and controls the UE accordingly so that it decreases or increases its transmission power (see technical specification 3G TS 25.214, version 3.1.1 published in December 1999 by the 3GPP). This regulation between node B and the UE is called the inner loop. It is relatively fast since the UE can deal with a power decrease or increase command every 0.666 ms. The values of SIR estimated by node B 21 are fed back up to the RNC 22 which utilizes them to adjust the value of SIR_{target} in a slower outer loop (technical specification 3G TS 25.331 on the RRC layer, version 3.2.0, published in March 2000 by the 3GPP).

The UTRAN 20 uses a code division multiple access technique (CDMA), according to which a communication channel between a base station 21 and a mobile station 30 is defined by a spreading code modulating the sequence of information symbols to be transmitted. The orthogonality of the various spreading codes allows the receiver to extract the signal which is addressed to it. Power control is performed code by code. The measurements performed by the UEs and nodes B are detailed in the 3G TS 25.215 technical specification, version 3.2.0 published in March by the 3GPP:

The parameter UTRAN_code power, measured by node B, represents the power transmitted by the base station to the UE on a given code. The RRC protocol allows the RNC to have this measurement transmitted to it;

The parameter CPICH_RSCP, measured by the UE, represents the power received by the UE from the base station on a pilot code. The RRC protocol allows the RNC to have this measurement transmitted to it;

The parameter UE_TX_power, measured by the UE, represents the power transmitted by the UE. The RRC protocol also allows the RNC to have this measurement transmitted to it;

The parameter RSCP (“Received Signal Code Power”), measured by node B, represents the power received by the base station from the UE on a code;

The parameter ISCP (“Interference Signal Code Power”), measured by node B, represents the interference power received by the base station on a code.

In the current state of the specifications in relation to UMTS in frequency duplex mode (FDD), the RSCP and ISCP powers are measured by node B, but are not fed back up to the RNC (the value fed back up in the outer loop is the SIR, given by (RSCP/ISCP)xSF, where SF is the channel spreading factor). Provision may therefore be made to enhance the signaling on the Iub interface (technical specification 3G TS 25.433, version 3.1.0 published in December 1999 by the 3GPP) so that node B feeds back the RSCP and ISCP powers too. A corresponding modification can be made on the Iur interface for the case where node B serving the terminal is not connected directly to the RNC where the RRC task (SRNC) is executed. The SRNC can then estimate the power PE transmitted by the UE, given by:

PE=RSCP−(CPICH_{—}RSCP−UTRAN_{—}code_{—}power).

Otherwise, it can be based on the value PE′=UE_TX_power transmitted to it by the UE in the RRC layer.

With the RSCP and ISCP powers and the target SIR_{target} which it has assigned to node B, the RNC can estimate the transmit power control (TPC) bits which are supplied by node B to the UE. By filtering these TPC bits, the RNC 22 can determine whether node B is in a phase where it requests the terminal to decrease or to increase its transmission power, on average. By observing the movements of the parameter PE (or PE′) and by comparing them with the estimated TPC bits, possibly filtered, the RRC layer can detect terminals which do not respond suitably to the power control. For example, if for a certain time (for example of the order of a few seconds), the UE receives the instruction to lower its transmission power and if nevertheless the estimated transmission power PE does not decrease or continues to increase, the RNC can diagnose that the power regulation is not operating properly in the terminal.

As a variant, the RSCP parameter and the TPC bits supplied to the UE (or a filtered value of these TPC bits) could be fed back up to the RNC by node B.

In the case where the UE communicates in macrodiversity mode with several base stations, the above detection proceeds by combining the estimated TPC bits for the various stations. It will thus be possible to diagnose a defect if, for a certain time, the UE receives from each of the base stations, the instruction to lower its transmission power and if nevertheless the estimated transmission power PE does not decrease or continues to increase.

The decision to classify a faulty terminal in terms of transmission power could also be taken at the level of nodes B.

Other types of defects of terminals can be detected by the RAN. In particular, the terminal may have problems in the implementation of one or more of the protocols used on the Uu interface, such as the RLC (“Radio Link Control”) and MAC (“Medium Access Control”) layer-2 protocols. These protocols are described respectively in the technical specifications 3G TS 25.322, version 3.2.0 and 3G TS 25.321, version 3.3.0 which were published in March 2000 by the 3GPP. The RNC 22 which comprises the RLC and MAC modules in conjunction with those present in the UE 30 (FIG. 3), can detect protocol errors such as for example erroneous formats in the protocol data units (PDU), transmitted by the UE.

Protocol errors may also be detected in the RRC protocol. For example, a faulty terminal may disregard or misinterpret instructions from the RNC to adopt given states or configurations. The RNC will then note the inability of the UE to behave itself in accordance with the expected state.

The RNC may furthermore detect UEs which make excessive use of radio resources shared with other mobile stations, such as, for example common channels provided for random access to the network.

1. A cellular radiocommunication system comprising on the one hand a network core (10) comprising switches (11-13) and subscriber management means (14) and on the other hand at least one radio access network (20) connected to at least one switch of the network core and comprising base stations (21) capable of communicating by radio with mobile stations (30), each mobile station comprising a terminal (31) associated with a subscriber identification module (32) in which the network core. comprises means of interrogation of a mobile station through the access network so as to obtain an identity of the terminal of the interrogated mobile station, characterized in that the access network comprises means for detecting defects of the mobile stations, so as to address to the network core a warning message identifying a mobile station for which a defect has been detected, and in that the means of interrogation are controlled to interrogate a mobile station in order to obtain the identity of its terminal in response to the receipt of a warning message identifying said mobile station.

2. The system as claimed in claim 1, wherein the network core (10) comprises at least one database of faulty terminals (15) containing records relating to terminals (31) whose identity has been obtained by the means of interrogation in response to the receipt of a warning message.

3. The system as claimed in claim 2, wherein the warning message comprises a subscriber identity for identifying the mobile station (30), and said subscriber identity is included in that record of the database of faulty terminals (15) which relates to the terminal (31) whose identity is obtained by the means of interrogation in response to the receipt of said warning message.

4. The system as claimed in claim 2 or 3, wherein the warning message comprises an indication of type of the defect detected and said indication of type is included in that record of the database of faulty terminals (15) which relates to the terminal (31) whose identity is obtained by the means of interrogation in response to the receipt of said warning message.

5. The system as claimed in any one of claims 2 to 4, wherein the warning message comprises an indication of level of severity of the detected defect, and said indication of level of severity is included in that record of the database of faulty terminals (15) which relates to the terminal (31) whose identity is obtained by the means of interrogation in response to the receipt of said warning message.

6. The system as claimed in any one of claims 2 to 5, wherein the network core (10) comprises means (16) for sending an alert message, through the radio access network (20), to at least one mobile station (30) whose terminal (31) forms the subject of a record in the database of faulty terminals (15).

7. The system as claimed in any one of claims 2 to 6, wherein the network core (10) comprises inhibition means for preventing at least one mobile station (30) whose terminal (31) forms the subject of a record in the database of faulty terminals (15) from communicating by way of the radio access network (20).

8. The system as claimed in any one of the preceding claims, wherein the subscriber management means comprise at least one database of subscribers (14) containing respectively records relating to the subscriber identification modules (32), and wherein the terminal identity obtained by the means of interrogation in response to the receipt of a warning message identifying a mobile station (30) is included in that record of the subscriber database which relates to the subscriber identification module of said mobile station.

9. The system as claimed in claim 8, wherein the subscriber management means (14) are arranged to process registration requests received from the mobile stations through the radio access network (20), the processing of a registration request comprising, for a mobile station (30) comprising a subscriber identification module (32) whose record in the database of subscribers includes a faulty-terminal identity, a control of the interrogation means to interrogate said mobile station in order to obtain the identity of its terminal, and a comparison between the terminal identity thus obtained and said faulty-terminal identity.

10. The system as claimed in claim 9, wherein the subscriber management means (14) are arranged to control the sending of an alert message to said mobile station (30) through the radio access network (20) when said comparison reveals identical terminal identities.

11. The system as claimed in claim 9 or 10, wherein the subscriber management means (14) are arranged to reject the registration request when said comparison reveals identical terminal identities.

12. The system as claimed in any one of the preceding claims, wherein the means for detecting defects comprise means for detecting errors of implementation, by a mobile station, of communication protocols used between the radio access network (20) and the mobile stations (30).

13. The system as claimed in any one of the preceding claims, wherein the means for detecting defects comprise means for detecting excessive use, by a mobile station, of radio resources shared with other mobile stations.

14. The system as claimed in any one of the preceding claims, wherein the means for detecting defects comprise means for monitoring the power transmitted by the mobile stations (30).

15. The system as claimed in claim 14, wherein the radio access network (20) uses a code division multiple access technique according to which a communication channel between a base station and a mobile station is defined by a respective spreading code, the access network comprising radio network controllers connected to switches of the network core, which supervise the base-stations and ensure control of the radio resources in the access network.

16. A network core for a cellular radiocommunication system, comprising switches (11-13) and subscriber management means (14), the switches being connected to at least one radio access network (20) comprising base stations (21) capable of communicating by radio with mobile stations (30), each mobile station comprising a terminal (31) associated with a subscriber identification module (32), the network core (10) comprising means of interrogation of a mobile station through the access network so as to obtain an identity of the terminal of the interrogated mobile station, characterized in that the means of interrogation are controlled to interrogate a mobile station in order to obtain the identity of its terminal in response to the receipt of a warning message identifying said mobile station.

17. The network core as claimed in claim 16, furthermore comprising at least one database of faulty terminals (15) containing records relating to terminals (31) whose identity has been obtained by the means of interrogation in response to the receipt of a warning message.

18. A radio access network for a cellular radiocommunication system, comprising base stations (21) capable of communicating by radio with mobile stations (30) and radio network controllers (22) connected to switches (11, 12) of a network core, which supervise the base stations and ensure control of the radio resources in the access network (20), characterized in that it comprises means for detecting defects of the mobile stations, so as to address to the network core (10) a warning message identifying a mobile station for which a defect has been detected.
